(19) United States
(12) Patent Application Publication
(10) Pub. No.: US 2014/0104178 A1
(43) Pub. Date: Apr. 17, 2014

(54) ELECTRONIC DEVICE FOR PERFORMING MODE COVERSION IN PERFORMING MEMO FUNCTION AND METHOD THEREOF

(71) Applicant: Samsung Electronics Co., Ltd, Gyeonggi-do (KR)

(72) Inventor: Cheol-Hun JO, Gyeonggi-do (KR)

(73) Assignee: Samsung Electronics Co., Ltd, Gyeonggi-do (KR)

(21) Appl. No.: 14/019,879

(22) Filed: Sep. 6, 2013

(30) Foreign Application Priority Data
Oct. 15, 2012 (KR) 10-2012-0114175

(51) Int. Cl. G06F 3/01

(52) U.S. Cl. CPC G06F 3/01
USPC 345/168; 345/173

(57) ABSTRACT

An electronic device for performing mode conversion in performing a memo function and a method thereof are provided. The method includes sensing touch input from an input unit and displaying a moving trajectory of the input unit, converting a mode setup state from a first mode to a second mode when receiving a mode conversion signal through selection of a certain region of the input unit from the input unit, and displaying the moving trajectory of the input unit according to set transparency. The selection may include actuation of a switch or button of the input unit.

### CLAIM OF PRIORITY

This application claims the benefit of priority under 35 U.S.C. §119(a) from a Korean patent application filed in the Korean Intellectual Property Office on Oct. 15, 2012 and assigned Serial No. 10-2012-0114175, the entire disclosure of which is hereby incorporated by reference in its entirety.

### BACKGROUND

1. Field of the Invention

The present disclosure relates to an electronic device for performing various functions. More particularly, the present disclosure relates to performing a memo function in the electronic device and an apparatus and method thereof

2. Description of the Related Art

As functions of an electronic device continue to be developed, a user may write a memo on the electronic device using an input unit that can include a keypad, touchpad, or a microphone, instead of writing a memo on a paper with a pen. For example, the user may execute a memo application stored in the electronic device, input a certain information item to the electronic device, and store the input information item in the electronic device. Also, the memo application of the electronic device has at least two mode classifications, namely a normal mode and a secret mode, and provides various functions to the user. For example, when the electronic device executes the memo application in the secret mode, the privacy of the memo writer is protected because the electronic device does not display contents input from the input unit as a foreground.

When a conventional electronic device executes a stored memo application, the conventional must allow a user to select any one of two modes such as the normal mode and the secret mode. In more detail, when the conventional electronic device executes the memo application, it must operate in one mode selected by the user between the normal mode and the secret mode. For example, if the conventional electronic device executes the memo application in the normal mode, it operates in only the normal mode. If the conventional electronic device executes the memo application in the secret mode, it operates in only the secret mode.

However, there is a problem in that the conventional electronic device executes the memo application in only one of the normal mode and the secret mode according to the mode setting of the memo application when the memo is created. Accordingly, while writing a memo on the electronic device in the normal mode and the user now wants to write some material in the memo that is confidential, the user must stop an executed normal mode and convert the normal mode into the secret mode to write contents necessary for maintaining confidentiality, and write the memo over again in the secret mode.

Therefore, there is an urgent need to develop an electronic device capable of freely performing mode conversion according to needs of the user after or during execution of the memo application.

### SUMMARY

An aspect of the present disclosure is to provide an apparatus and method for easily performing mode conversion without utilizing a series of screens associated with a mode conversion process. More particularly, the apparatus and method as described in this disclosure does not require entering a separate menu for mode conversion while a user writes a memo.

Another aspect of the present disclosure provides an apparatus and method for maintaining security of a user by presetting transparency for certain contents displayed in a secret mode.

Another aspect of the present disclosure provides an apparatus and method for satisfying various desires of a user by setting a fade-out function.

In accordance with an aspect of the present invention, an operational method of an electronic device includes sensing a touch input from an input unit and displaying a moving trajectory of the input unit, converting a mode setup state from a first mode to a second mode when receiving a mode conversion signal through a push of a certain region of the input from the input unit, and displaying the moving trajectory of the input means according to set transparency.

In accordance with another aspect of the present invention, an operational method of an input unit includes determining whether a set region is pushed and transmitting a mode conversion signal to an electronic device when the set region is pushed.

In accordance with another aspect of the present invention, an electronic device is provided that includes a processor unit for converting a mode setup state from a first mode to a second mode when receiving a mode conversion signal through a push of a certain region of the input unit from the input unit and a touch screen for sensing touch input from the input unit, displaying a moving trajectory of the input unit, and displaying the moving trajectory of the input unit according to set transparency.

In accordance with another aspect of the present invention, an input unit includes hardware comprising a controller for determining whether a set region is pushed and a communication module with hardware including a transmitter, receiver or transceiver for transmitting a mode conversion signal to an electronic device when the set region is pushed.

### BRIEF DESCRIPTION OF THE DRAWINGS

The above and other aspects, features and advantages of the present disclosure will be better-appreciated by a person ordinary skill in the art from the following detailed description taken in conjunction with the accompanying drawings, in which:

FIG. 1 illustrates an electronic device that performs mode conversion in performing a memo function according to one embodiment of the present disclosure;

FIGS. 2A, 2B, 2C and 2D are screens illustrating a process of displaying an information item input from an input unit according to set transparency according to one embodiment of the present disclosure ;

FIGS. 3A, 3B, 3C and 3D are screens illustrating a process of receiving a mode conversion signal from an input unit and displaying an input information item according to a converted mode in an electronic device according to one embodiment of the present disclosure;

FIGS. 4A, 4B, 4C and 4D are screens illustrating a process of allowing a user to set a fade-out function and displaying a certain information item input from an input unit on a touch screen according to a set fade-out time according to one embodiment of the present disclosure;

FIGS. 5A, 5B, 5C and 5D are screens illustrating a process of displaying a certain information item input from an input unit on a touch screen according to set transparency and a set fad-out time according to one embodiment of the present disclosure;

FIG. 6 is a flowchart illustrating an example of an operational process of an electronic device according to one embodiment of the present disclosure;

FIG. 7 is a flowchart illustrating an example of an operational process of an input unit according to one embodiment of the present disclosure;

FIG. 8 is a block diagram illustrating configuration of an input unit according to one embodiment of the present disclosure; and

FIG. 9 is a block diagram illustrating configuration of an electronic device according to one embodiment of the present disclosure.

### DETAILED DESCRIPTION

Exemplary embodiments of the present disclosure will be described herein below with reference to the accompanying drawings. In the following description, well-known functions or constructions may not be described in detail when their inclusion would obscure appreciation of the disclosure by a person of ordinary skill in the art with unnecessary detail of such well-known functions or constructions.

The definition of the terms “unit” or “module” as referred to herein are defined by the Applicant to be understood as constituting hardware circuitry such as a processor, sub-processor or microprocessor configured for a certain desired functionality, or a communication module containing hardware such as transmitter, receiver or transceiver, or a non-transitory medium comprising machine executable code that is loaded into and executed by hardware for operation, in accordance with statutory subject matter under 35 U.S.C. §101 and such terms do not constitute software per se.

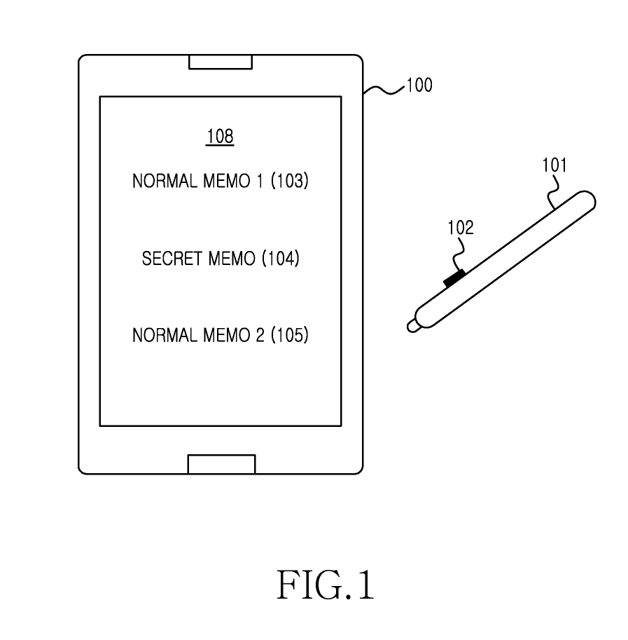

FIG. 1 illustrates an electronic device that performs mode conversion in performing a memo function according to one embodiment of the present disclosure.

As shown in FIG. 1, the electronic device 100 that performs the mode conversion in performing the memo function may include a portable (handheld) electronic device 100 (hereinafter, referred to as an electronic device) and an input unit 101 for inputting a certain information item to the electronic device.

First of all, the electronic device may receive a certain information item from the input unit 101. In more detail, the electronic device stores at least one application that is executed by hardware such as a processor. The electronic device may execute a memo application that can perform a memo function from among the stored applications and receive a certain information item from the input unit 101. In other words, the electronic device may execute the memo application, receive the certain information item, and also store the received information item.

Herein, the memo application stored in the electronic device may be executed in two modes such as, for example, a normal mode and a secret mode. In more detail, the electronic device may execute the memo application, receive a mode conversion signal through actuation of a set region 102 of the input unit 101 from the input unit 101, and execute the memo application in two modes of the normal mode and the secret mode. More particularly, if the memo application stored in the electronic device is initially set to the normal mode, the electronic device 100 may display on touch display screen 108 a certain information item input from the input unit 101 on a touch screen thereof. For example, if the electronic device receives a certain memo of a “normal memo 1” from the input unit 101, the electronic device may display the memo of the “normal memo 1” 103 input from the input unit 101 as written on the touch screen 108.

However, if the electronic device 100 receives a mode conversion signal from the input unit 101 while operating in the normal mode, or if the electronic device 100 receives a certain information item in a state where the set region 102 of the input unit 101 is actuated, it may convert a mode state from the normal mode to the secret mode. In more detail, if the input unit 101 senses that the set region 102 is pushed, it may transmit a mode conversion signal to the electronic device. Or, the electronic device may 100 convert a mode state from the normal mode to the secret mode and store a certain information item input in a state where the set region 102 of the input unit 101 is pushed. When the electronic device 100 receives a certain information item from the input unit 101, the electronic device may display the received certain information item on the touch screen 108.

For example, after the electronic device 100 is converted into the secret mode, when receiving a memo of a “secret memo” from the input unit 101, the electronic device 100 may display the received memo of the “secret memo” 104 on the touch screen 108. In other words, when a conventional electronic device (not shown) executes a stored memo application, the conventional electronic device must allow a user to select any one of two modes such as the normal mode and the secret mode. In more detail, when the conventional electronic device executes the memo application, such a conventional electronic device must operate in any one of the normal mode and the secret mode, which is selected by the user.

For example, if the electronic device executes the memo application in the normal mode, then the memo application operates in only the normal mode. If the electronic device executes the memo application in the secret mode, then the memo application operates in only the secret mode.

However, there is an advantage in that the electronic device according to one embodiment of the present disclosure may convert two modes of the normal mode and the secret mode easily. In more detail, if the electronic device 108 receives a mode conversion signal from the input unit 101 while executing the memo application and operating in the normal mode, or if the electronic device 100 receives a certain information item in a state where the set region 102 of the input unit 101 is set, there is an advantage in that the electronic device may operate in the secret mode and reduce interaction of the user.

Also, when the electronic device 100 receives a certain information item from the input unit 101, the electronic device may display the received certain information item on the touch screen according to “set transparency”. Herein, the “set transparency” may be defined as transparency in which the electronic device 100 may display received certain information item on the touch screen 108 when the electronic device receives the certain information item from the input unit 101 in the secret mode.

For example, if the transparency is set to 100% when the electronic device executes the memo application in the secret mode, when the electronic device receives a certain information item of a “secret memo” from the input unit 101 in operating in the secret mode, and the touch screen 108 does not display the received certain information item of the “secret memo” 104 on the touch screen.

Also, if the transparency is set to 50% when the electronic device 100 executes the memo application in the secret mode, when the electronic device 100 receives the certain information item of the “secret memo” from the input unit 101 in operating the secret memo, the touch screen 108 displays the received certain information item of the “secret memo” 104 at the transparency of 50% on the touch screen.

For example, when receiving a secret memo, the conventional electronic device does not display an input certain information item. Accordingly, the user of the conventional electronic device may not verify the input information item. In more detail, the conventional electronic device is always set to 100% in transparency when executing the memo application in the secret mode, and there is no usual-settable transparency.

However, in contrast, the electronic device according to one embodiment of the present disclosure may receive the transparency setting directly from the user when executing the memo application in the secret mode and display a secret memo item according to the received transparency on the touch screen. In other words, there is an advantage in that the user may verify an information item input by himself or herself in real time when the electronic device executes the memo application in the secret mode according to set transparency. For example, if the electronic device receives a transparency setting of 30% from the user and if the electronic device receives a secret memo item from the input unit 101 in executing the memo application in the secret mode, the touch screen display 108 may display the received secret memo item according to the transparency of 30%. Accordingly, the user may input a certain information item while verifying a secret memo item input by himself or herself Because the input secret memo item is displayed at the user-set transparency of 30% on the touch screen of the electronic device, there is an advantage in that others around the electronic device may not see the secret memo item very easily from glancing at the display.

Also, after operating in the secret mode, if the electronic device according to one embodiment of the present disclosure receives a mode conversion signal from the input unit 101, the electronic device 100 may operate in the normal mode again. In more detail, the electronic device according to one embodiment of the present disclosure may perform mode conversion between the normal mode and the secret mode freely, irrespective of the number of times performing the mode conversion. For example, after the electronic device displays the secret memo item of the “secret memo” 104, when the electronic device receives a mode conversion signal from the input unit 101, the electronic may convert the current mode state from the secret mode to the normal mode. Thereafter, the electronic device may display a certain information item of a “normal memo 2” 105 received from the input unit 101 on the touch screen 108. The description is given for the example in which the electronic device according to one embodiment of the present disclosure converts the normal mode into the secret mode and then converts the secret mode back into the normal mode again. However, an artisan should appreciate there is no limit to the number of times mode conversion can be performed between the normal mode and the secret mode.

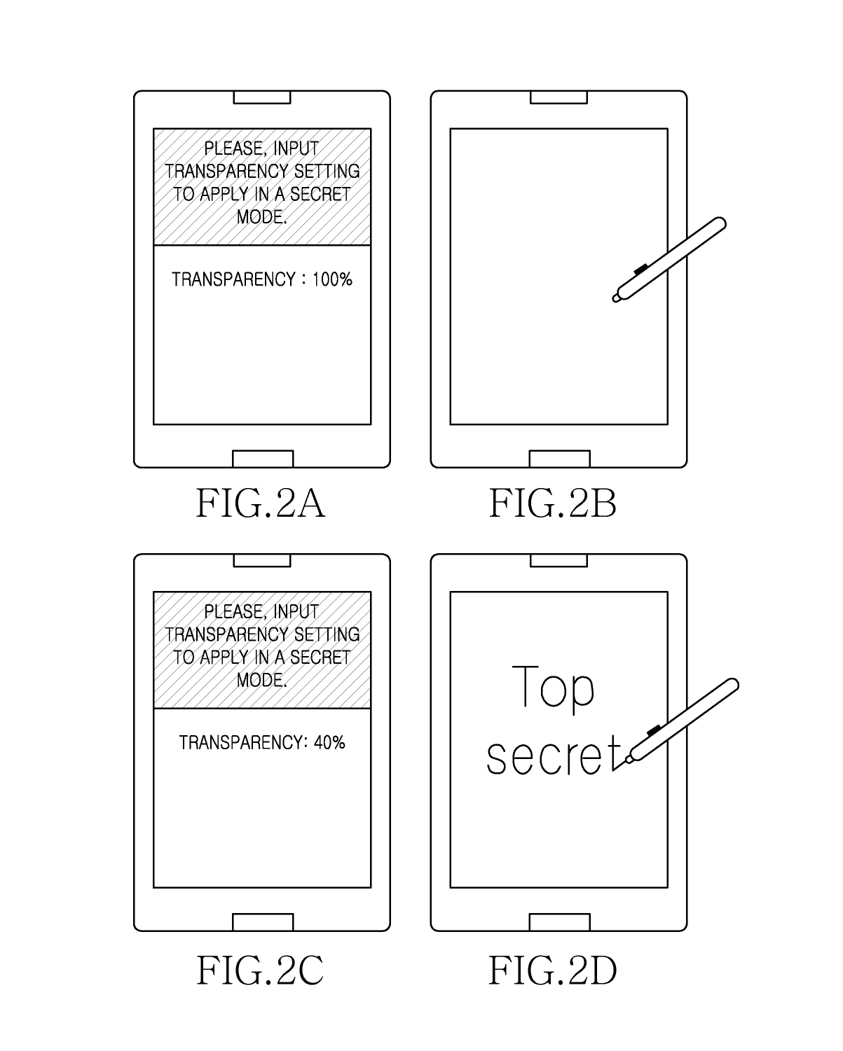

FIGS. 2A, 2B, 2C and 2D are screens illustrating a process of displaying an information item input from an input unit according to set transparency according to one embodiment of the present disclosure. FIGS. 2A and 2B are screens illustrating a process of allowing a user to set transparency to 100% and displaying an information item input from an input unit on a touch screen of an electronic device according to one embodiment of the present disclosure.

As shown in FIG. 2A, the electronic device may receive a transparency setting to apply in a secret mode when executing a memo application. In more detail, the electronic device may display a secret memo input from the input unit on a touch screen thereof when executing the memo application according to the transparency setting received from the input unit 101.

For example, the electronic device may display a guide message that can state, as a non-limiting example, “please, input transparency to apply in a secret mode”. The electronic device may receive the transparency setting for application in the secret mode from a user ranging from 100% to 0%. In other words, if the electronic device receives a transparency setting instruction to apply transparency in the secret mode at 100%, the electronic device may display a secret memo item input from the input unit at transparency of 100% on a touch screen thereof. Also, if the electronic device receives transparency to apply transparency in the secret mode at 0%, the touch screen display 108 may display a secret memo item input from the input unit at transparency of 0% on the touch screen. Because the electronic device according to one embodiment of the present disclosure receives the transparency of 100%, the electronic device may display an information item input from the input unit on the display in the secret mode at the transparency setting of 100% on the touch screen. For example, if the electronic device receives a secret memo of a “secret” from the input unit 102, the electronic device may display the secret memo of the “secret” on the touch screen according to the transparency setting of 100%. In other words, as shown in FIG. 2B, because the transparency is set to 100%, the user may not verify the memo of the “secret” input by himself or herself directly. When other people approach the electronic device 100 of the user, the user may set transparency to 100%. For example, when the user must input an importance secret memo that is not to be disclosed to others while traveling by public transportation such as by subway, he or she may set transparency to 100% and write the secret memo.

FIGS. 2C and 2D are screens illustrating a process of allowing a user to set transparency to 40% and displaying an information item input from an input unit on a touch screen of an electronic device according to another embodiment of the present disclosure.

First of all, as shown in FIG. 2C, the electronic device may receive the transparency setting from the input unit 101 for application in a secret mode when executing a memo application. In more detail, the electronic device may display a secret memo input from the input unit on the touch screen when executing the memo application according to the set transparency. For example, the electronic device may display a guide message that may state “please, input transparency setting to apply in a secret mode”. The electronic device may receive a user transparency setting to apply in the secret mode ranging from 100% to 0% r. In other words, if the electronic device receives a transparency setting to apply in the secret mode at 100%, the electronic device may display a secret memo item input from the input unit at transparency of 100% on the touch screen. Also, if the electronic device receives a transparency setting of 0% to apply in the secret mode, the electronic device may display on the touch screen a secret memo item input from the input unit at transparency of 0%. In addition, the electronic device according to another embodiment of the present disclosure receives a transparency setting of 40%, and as a result may display on the touch screen an information item input from the input unit in the secret mode at the transparency setting of 40%. For example, if the electronic device receives a secret memo of a “top secret” from the input unit, the electronic device may display the secret memo of the “top secret” on the touch screen at the transparency setting of 40%. In other words, as shown in FIG. 2D, because the transparency is set to 40%, the user may verify the memo of the “top secret” input by himself or herself directly.

In contrast, when a conventional electronic device receives a secret memo, because such a conventional device does not display the input secret memo, a user of the conventional electronic device may not verify the input secret memo. In more detail, in the conventional device the transparency is always set to 100% when the conventional electronic device executes a memo application in a secret mode.

However, the electronic device according to the present disclosure may receive the transparency setting directly from the user when executing the memo application in the secret mode and display a secret memo item on the touch screen according to the received transparency. Moreover, when the electronic device executes the memo application in the secret mode according to set transparency, there is an advantage in that the user may verify an input information item in real time. For example, if the electronic device receives transparency of 40% from the user and if the electronic device receives a secret memo item from the input unit when executing the memo application in the secret memo, the electronic device may display the received secret memo item according to the set transparency of 40%. Accordingly, the user may input a certain information item while verifying the secret memo item input by himself or herself in real time. Because the input secret memo item is displayed on the touch screen of the electronic device at the transparency setting of 40%, there is an advantage in that other persons in the vicinity of the electronic device cannot easily read the secret memo item displayed at the 40% transparency setting.

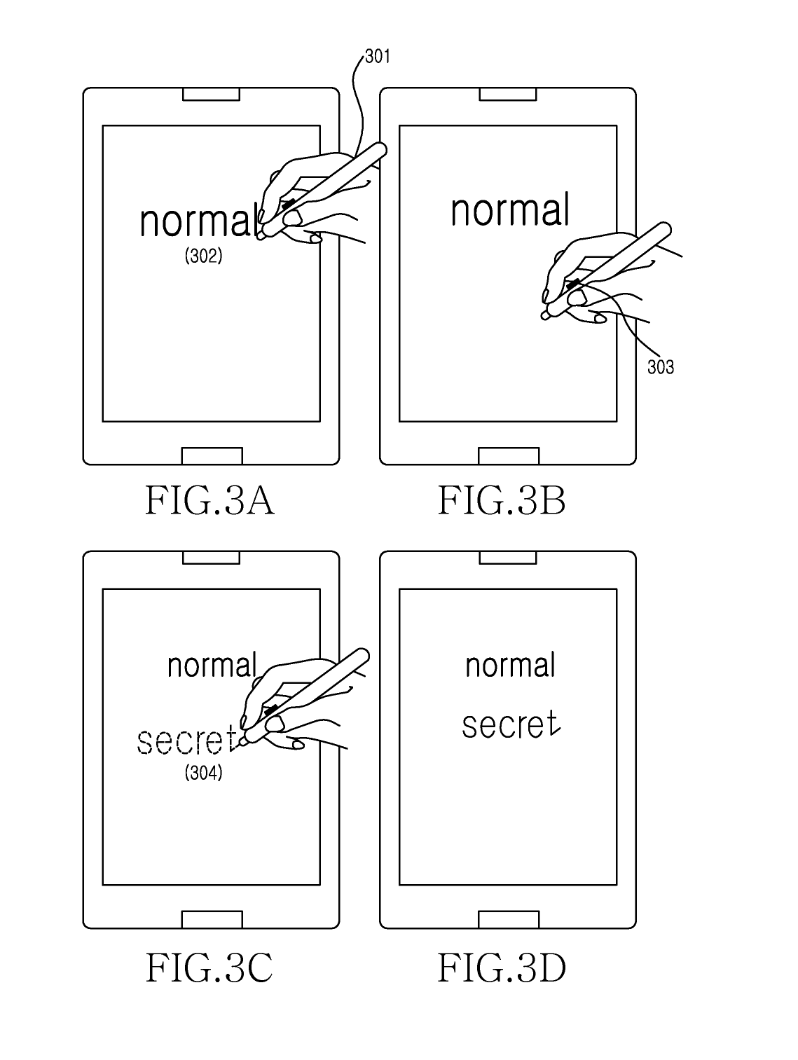

FIGS. 3A, 3B, 3C and 3D are screens illustrating an exemplary operation of process of receiving a mode conversion signal from an input unit and displaying an input information item according to a converted mode in an electronic device according to one embodiment of the present disclosure. Referring now to FIG. 3A, the electronic device may receive a certain information item from an input unit 301. In more detail, the electronic device includes hardware, for example, a processor or microprocessor that executes at least one application, and non-transitory storage that stores at least one application. The electronic device may execute a memo application capable of performing a memo function among the stored applications and receive a certain information item from the input unit 301. In other words, if the memo application stored in the electronic device is initially set to a normal mode, the electronic device may display the certain information item input from the input unit 301 on a touch screen thereof. For example, if the electronic device receives a certain memo of a “normal” from the input unit 301, it may display the memo of the “normal” 302 input from the input unit 301 on the touch screen.

As shown in FIG. 3B, the electronic device may receive a mode conversion signal from the input unit 301 and convert a mode state from the normal mode to the secret mode. In more detail, if the input unit 301 senses that a set region 303 is actuated, the input may transmit a mode conversion signal to the electronic device, the electronic device may receive a certain information item from the input unit 301 and execute the normal mode and the secret mode simultaneously on one screen, without displaying the normal mode and the secret mode on different screens.

However, there is an advantage in that the electronic device according to one embodiment of the present disclosure may execute the normal mode and the secret mode simultaneously on one screen. Or, the electronic device according to one embodiment of the present disclosure may convert a mode state from the normal state to the secret mode and store a certain information item input in a state where the set region 303 of the input unit 301 is actuated. For example, in a case where the electronic device is in a state in which the memo application is executed and the executed memo application is in the normal mode. The electronic device may convert a mode state from the normal mode to the secret mode and store a certain information item input in a state where the set region 303 of the input unit 301 is actuated as a background thereof

As shown in FIG. 3C, when the electronic device receives a certain information item from the input unit 301, it may display the received certain information item on the touch screen according to set transparency. For example, after the electronic device is converted into the secret mode, if the electronic device receives a secret memo of a “secret” from the input unit 301, it may display the received secret memo of the “secret” 304 on the touch screen. In other words, when the electronic device receives the secret memo from the input unit 301, the electronic device may display the received secret memo on the touch screen according to set transparency. For example, if transparency is set to 50% when the electronic device executes the memo application in the secret mode and the electronic device receives the secret memo of the “secret” from the input unit 301 while in operating in the secret memo mode, the electronic device may display the received secret memo of the “secret” 304 on the touch screen according to the transparency of 50%. Whereas shown in FIG. 3C, this secret memo is harder to read from a nearby vantage point, as opposed to items in the normal mode 302. There is an advantage in that the electronic device according to one embodiment of the present disclosure may receive the transparency setting directly from the user when executing the memo application in the secret mode and display a secret memo item on the touch screen according to the received transparency setting. For example, if the electronic device receives a transparency setting of 50% from the user and if the electronic device receives a secret memo item from the input unit 301 when executing the memo application in the secret mode, the electronic device may display the received secret memo item according to the transparency setting of 50%. Accordingly, the user may input a certain information item while verifying the secret memo item input by himself or herself Because the input secret memo item is displayed at the transparency setting of 50% on the touch screen of the electronic device, there is an advantage in that others around the electronic device will not be able to read the secret memo item easily.

FIG. 3D is a screen illustrating stored memo items according to one embodiment of the present disclosure.

In more detail, the electronic device may store information items input in the normal mode and the secret mode. As described above, the electronic device may store and display the normal memo of the “normal” 302 input in the normal mode and the secret memo of the “secret” 304 displayed according to the transparency setting of 50%. Particularly, the secret memo of the “secret” 304 displayed on the touch screen of the electronic device according to the transparency setting of 50% may be stored according to transparency of 100%. Accordingly, when the electronic device displays the stored memo, it may also display the secret memo stored in the secret mode on the touch screen according to the transparency setting of 100%.

It should also be appreciated that while the stylus shown has a pushbutton, there is no limit to the various constructions for both the stylus, and the actuator of the input means. For example, while a pushbutton is a type of electromechanical actuation, there can be an optical or capacitive sensing of one's finger to change the transparency setting. In addition, in the case of a button, it may be slide from a first position to second position, or there could be a plurality of positions, which the button is moved to for respective transparency settings. In addition, the electronic device itself can have the setting as, for example, a touch setting, where a user through a touch, tape, or other type of gesture, or by selection of an icon, for example, activates a setting screen controlled by a microprocessor, and user can enter, scroll select, or in any other way set the transparency. It is also within the spirit and scope of the invention, for example, one could actuate the input by making a gesture motion that is in the form of a numerical value that is sensed by the touch screen and used to set the transparency.

In addition, an artisan should also appreciate that the definition of touch as used throughout this disclosure and the appended claims includes “near-touch”, for example, bringing the stylus pen to within a certain distance from the touchscreen that it can be detected by the electronic device without physical contact.

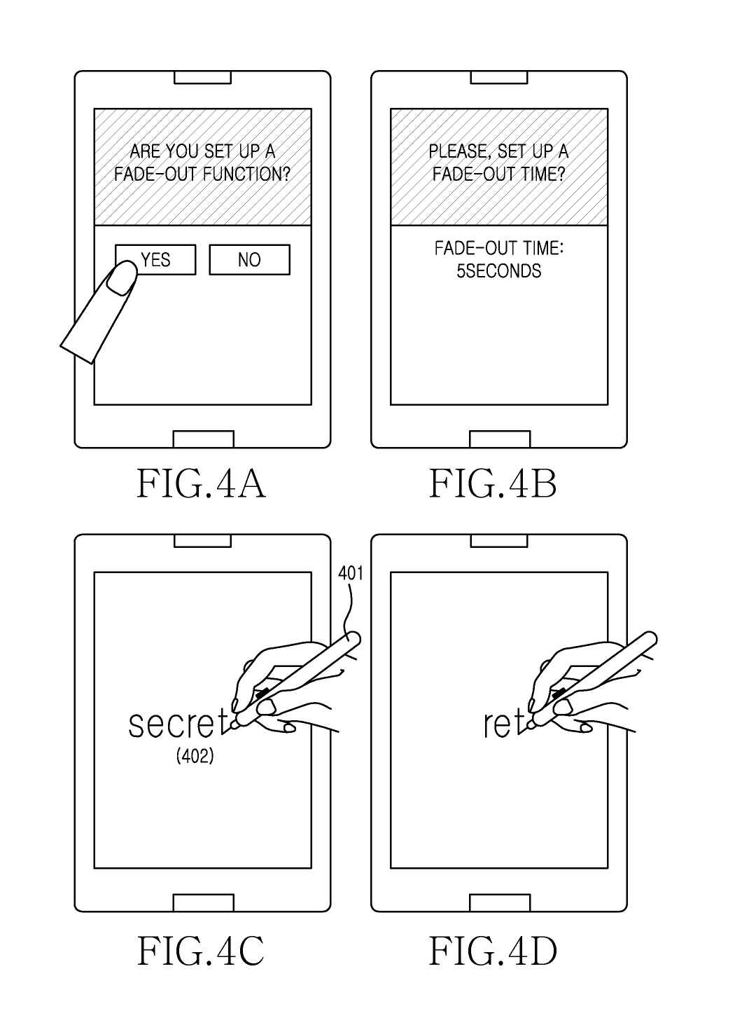

FIGS. 4A, 4B, 4C and 4D are screens illustrating a process of allowing a user to set a fade-out function and displaying a certain information item input from an input unit on a touch screen of an electronic device according to a set fade-out time according to one embodiment of the present disclosure.

First of all, as shown in FIG. 4A, the electronic device may display a guide message according to whether to set up a fade-out function. For example, the electronic device may display a guide message that “are you set up a fade-out function” on the touch screen. Herein, the fade-out function may be defined as a function for erasing a moving trajectory of an input unit, which is displayed according to set transparency, after a set time elapses. For example, if a fade-out time is set to 5 seconds, the fade-out function is a function for erasing a moving trajectory of the input unit, which is displayed on the touch screen according to a transparency setting, after 5 seconds elapse.

As shown in FIG. 4B, if the electronic device receives a command indicating that the user sets up the fade-out function, it may display a guide message about a fade-out time. For example, the electronic device may display a guide message that “please, set up a fade-out time”. Thereafter, if the electronic device receives a fade-out time from the user, the electronic device may store the received fade-out time. In other words, if the fade-out time of 5 seconds is stored in the electronic device, the electronic device may erase a moving trajectory of the input unit, which is displayed on the touch screen according to set transparency, after 5 seconds elapse.

As shown in FIG. 4C, if the electronic device receives a certain secret memo in a secret mode from an input unit 401, the electronic may display the received secret memo according to transparency setting. For example, after the electronic device is converted into the secret mode, if it receives a certain secret memo of a “secret” from the input unit 401, the electronic device may display the received secret memo of the “secret” 402 on the touch screen. In other words, when the electronic device receives the secret memo from the input unit 401, the electronic may display the received secret memo on the touch screen according to transparency setting.

For example, if transparency is set to 70% when the electronic device executes the memo application in the secret mode and if the electronic device receives the secret memo of the “secret” from the input unit 401 in operating in the secret mode, the electronic device may display the received secret memo of the “secret” 402 on the touch screen according to the transparency of 70%.

As shown in FIG. 4D, the electronic device may verify that the fade-out function is set up. In more detail, if the electronic device verifies that the fade-out function is set up, the electronic device may verify the set fade-out time. In other words, the electronic device may erase a moving trajectory displayed according to set transparency after the set fade-out time elapses.

For example, when the electronic device receives the secret memo of the “secret” from the input unit 401, the electronic device is assumed in this example to receive alphabetic characters of “ret” after 5 seconds elapse after receiving an alphabetic character of “s” first. If 5 seconds elapse after the secret memo of the “secret” is displayed because the fade-out time is set to 5 seconds, the electronic device may erase alphabetic characters of “sec” in the secret memo. There is an advantage in this construction in that the user may verify contents of a secret memo input by himself or herself in real time by setting the fade-out function and secure security by erasing a received secret memo after the set fade-out time elapses. One attempting to read what was written could not simply glance at the screen once as the fade out could even, as in this example, makes parts of words fade away prior to the entire word being written.

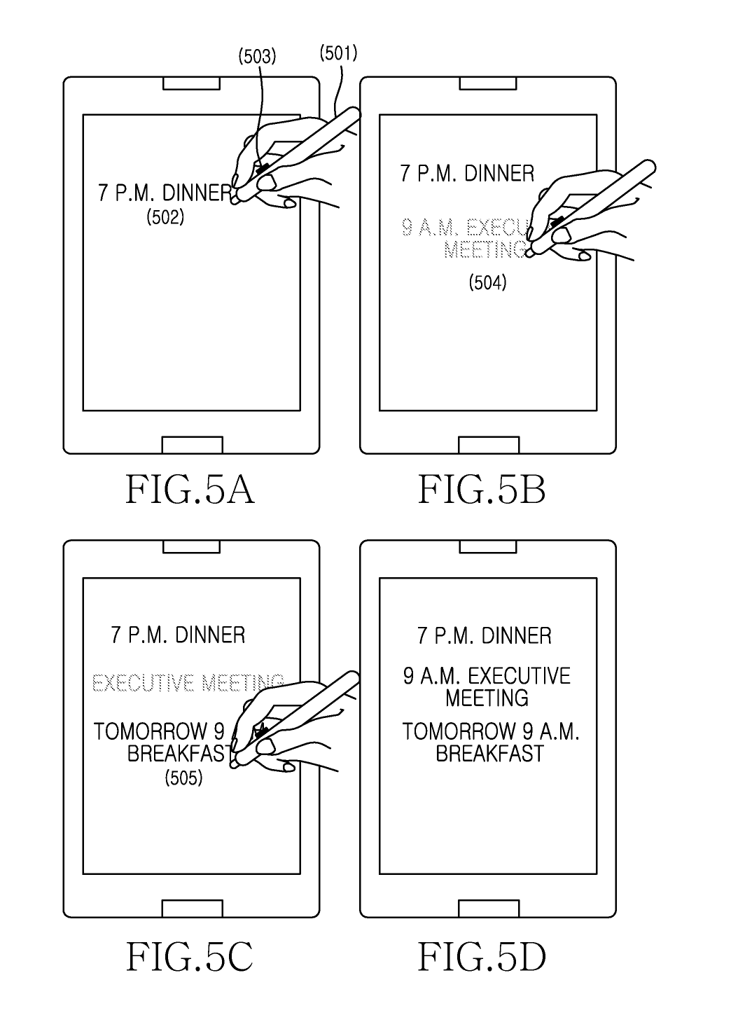

FIGS. 5A, 5B, 5C and 5D are screens illustrating a process of displaying a certain information item input from an input unit on a touch screen according to set transparency and a set fad-out time according to one embodiment of the present disclosure.

As shown in FIG. 5A, the electronic device may receive a certain information item from an input unit 501. In more detail, the electronic device stores at least one application. The electronic device may execute a memo application that performs a memo function from among a plurality of stored applications in the electronic device and receives a certain information item from the input unit 501. In other words, if the memo application that is stored in the electronic device is initially set to a normal mode, the electronic device may display the certain information items input from the input unit 501 on a touch screen thereof. For example, if the electronic device receives a certain memo of a “7 p.m. dinner” from the input unit 501, it may display the memo of the “7 p.m. dinner” 502 input from the input unit 501 on the touch screen. Thereafter, the electronic device may receive a mode conversion signal through an actuation of a set region 503 of the input unit 501 from the input unit 501 and convert a mode state from the normal mode to a secret mode. In more detail, if the input unit 501 senses that the set region 503 is actuated, the input unit may transmit the mode conversion signal to the electronic device. In other words, the electronic device may receive a certain information item from the input unit 501 and execute the normal mode and the secret mode simultaneously on one screen, without displaying the normal mode and the secret mode on different screens.

As shown in FIG. 5B, when the electronic device receives a certain secret memo from the input unit 501 in the secret mode, it may display the received secret memo according to a transparency setting. For example, after the electronic device is converted into the secret mode, if the electronic receives a certain secret memo of a “9 a.m. executive meeting” from the input unit 501, the electronic device may display the received secret memo of the “9 a.m. executive meeting” 504 on the touch screen. For example, if transparency is set to 60% when the electronic device executes the memo application in the secret mode and if the electronic device receives the secret memo of the “9 a.m. executive meeting” from the input unit 501, then the electronic device may display the received secret memo of the “9 a.m. executive meeting” 504 on the touch screen according to the transparency setting of 60%.

As shown in FIG. 5C, the electronic device may verify that the fade-out function is set up. In more detail, if the electronic device verifies that the fade-out function is set up, it may verify the set fade-out time. In other words, the electronic device may erase a moving trajectory displayed according to set transparency after the set fade-out time elapses. For example, when a fade-out time is set to 2 seconds and when the electronic device receives the secret memo of the “9 a.m. executive meeting” from the input unit 501, it is assumed that the electronic device receives a secret memo of an “executive meeting” after 2 seconds elapse after the “9” is received. If 2 seconds elapse after the secret memo of the “9 a.m. executive meeting” is displayed because the fade-out time is set to 2 seconds, the electronic device may erase a memo of “9 a.m.” in the secret memo. Thereafter, when the electronic device receives a mode conversion signal again from the input unit 501, the electronic device may convert a mode state from the secret mode which is currently operated to the normal mode. When converted into the normal mode, the electronic device may display a certain information item input from the input unit 501 on the touch screen. For example, if the electronic device receives a normal memo of “tomorrow 9 a.m. breakfast” from the input unit 501, the electronic device may display the received memo of the “tomorrow 9 a.m. breakfast”.

FIG. 5D is a screen illustrating stored memo items according to one embodiment of the present disclosure.

In more detail, the electronic device may store information items input in the normal mode and the secret mode. As described above, the electronic device may store the normal memos of the “7 p.m. dinner” 502 and the “tomorrow 9 a.m. breakfast”, which are input in the normal mode, and the secret memo of the “9 a.m. executive meeting” 504 displayed according to the transparency setting of 60%. Particularly, the secret memo of the “9 a.m. executive meeting” 504 displayed on the touch screen of the electronic device according to the transparency of 60% may be stored according to transparency of 100%. Accordingly, when the electronic device displays the stored memo, the electronic device may also display the secret memo stored in the secret mode on the touch screen according to the transparency of 100%.

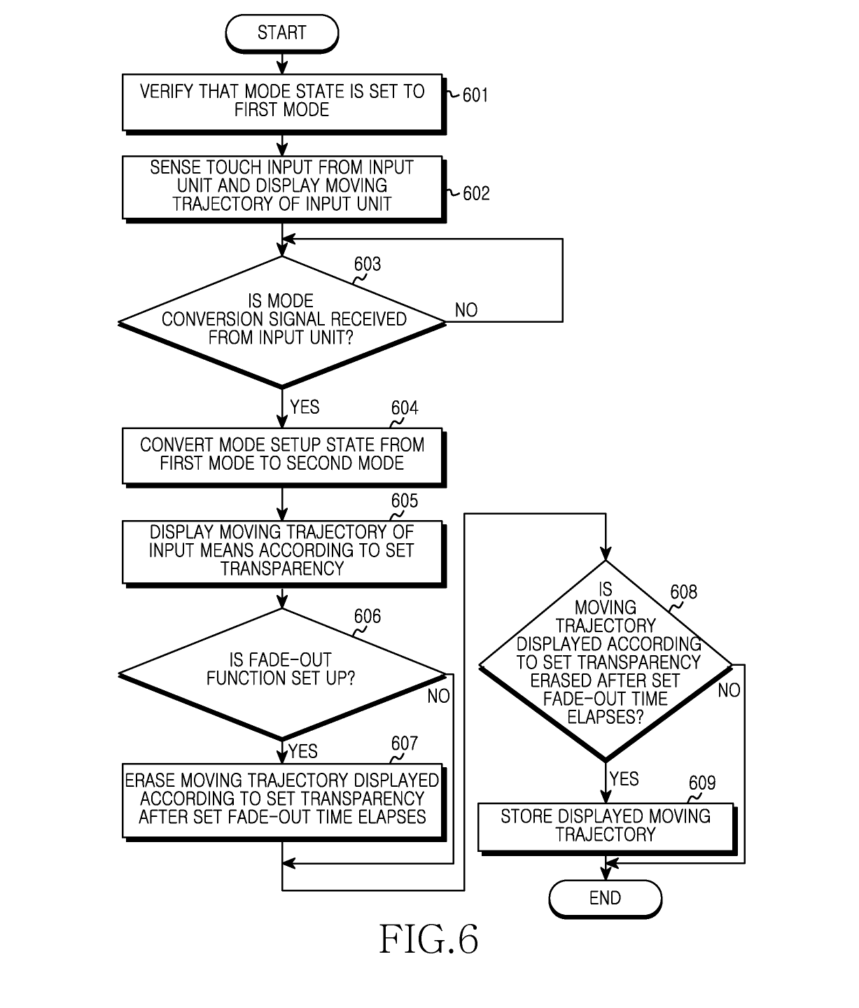

FIG. 6 is a flowchart illustrating a non-limiting operational process of an electronic device according to one embodiment of the present disclosure.

Referring now to FIG. 6, at (601), the electronic device may verify whether a mode state is set to a first mode. Herein, the first mode may be defined as a mode displaying on a touch screen a certain information item input from an input unit of the electronic device when the electronic device executes a memo application. In other words, the first mode may be defined as a normal mode among modes of the memo application.

After verifying that the mode state is set to the first mode, at (602) the electronic device may sense touch input from the input unit and display a moving trajectory of the input unit. In more detail, the electronic device may receive the touch input from the input unit and display a certain information item input from the input unit on the touch screen.

At (603), the electronic device may determine whether a mode conversion signal is received from the input unit. In more detail, the electronic device may determine whether the mode conversion signal is received from the input unit while operating in the general mode. That is, if the input unit senses that a set region is pushed, it may transmit the mode conversion signal to the electronic device.

At (604), if the electronic device receives the mode conversion signal from the input unit, it may convert a mode setup state from the first mode and a second mode. Herein, the second mode may be defined as a mode for displaying a certain information item input from the input unit on the touch screen according to a set transparency when the electronic device executes the memo application. In other words, the second mode may be defined as a secret mode from among modes of the memo application. Or, when a certain information item is received in a state where the set region of the input unit is pushed, the electronic device may convert a mode setup state from the normal mode which is currently operated to the secret mode. An artisan also understands and appreciates that the first mode and second mode are used for explanatory purposes and it is within the spirit of the disclosure that the constitution of the first mode and second mode could be reversed, for example, from what was explained above.

At (605), when converting of the mode setup state from the first mode to the second mode, the electronic device may display a moving trajectory of the input unit according to a transparency setting. For example, if transparency is set to 100% when the electronic device executes the memo application in the secret mode, and if the electronic device receives a certain information item of a “secret memo” from the input unit while operating in the secret mode, the electronic device does not display the received certain information item of the “secret memo” on the touch screen. Also, if transparency is set to 50% when the electronic device executes the memo application in the secret mode and if the electronic device receives the certain information item of the “secret memo” from the input unit in operating in the secret memo, the electronic device may display the received certain information item of the “secret memo” on the touch screen according to the transparency setting of 50%.

However, the electronic device according to one embodiment of the present disclosure may receive transparency directly from the user when executing the memo application in the secret mode and display a secret memo item on the touch screen according to the received transparency. In other words, there is an advantage in that the user may verify an information item input by himself or herself when the electronic device executes the memo application in the secret mode according to set transparency. For example, if the electronic device receives transparency setting of 30% from the user and if the electronic device receives a secret memo item from the input unit when executing the memo application in the secret mode, the electronic device may display the received secret memo item according to the transparency setting of 30%. Accordingly, the user may input a certain information item while verifying the secret memo item input by himself or herself in real time. Because the input secret memo item is displayed at the transparency setting of 30% on the touch screen of the electronic device, there is an advantage in that other people around the electronic device may not easily read the secret memo item. In addition, if there were a camera or video equipment operating as well by another person, there would still be much more difficulty in attempting to capture something written in the secret memory transparency setting,

With continued reference to FIG. 6, at (606), the electronic device may determine whether a fade-out function is set up. Herein, the fade-out function may be defined as a function for erasing a moving trajectory of the input unit, which is displayed according to set transparency, after a set time elapses. For example, if a fade-out time is set to 5 seconds, the fade-out function is a function for erasing a moving trajectory of the input unit, which is displayed on the touch screen according to set transparency, after 5 seconds elapse. It should also be appreciated that this determination of the electronic device is made by hardware, for example, circuitry that can include a processor, microprocessor, controller, which may be include integrated circuitry. In such a case the hardware is configured for operation.

If the electronic device has determined that the fade-out function is set up, then at (607) the electronic device may erase a moving trajectory displayed according to set transparency after a set fade-out time elapses. For example, when the fade-out time is set to 1 second and when the electronic device receives a secret memo of a “top secret information” from the input unit, there is an assumption in this example that the electronic device receives alphabetic characters of “top secret” after 1 second elapses after it receives alphabetic characters of the “top” first. If 1 second elapse after the secret memo of the “top secret information” is displayed because the fade-out time is set to 1 second, the electronic device may erase alphabetic characters of “top secret” in the secret memo. There is an advantage in that the user may verify contents of a secret memo input by himself or herself in real time by setting the fade-out function and secure security by erasing a received secret memo after the set fade-out time elapses.

If at (606) the fade-out function is not set up, or if the electronic device erases the moving trajectory displayed according to the set transparency after the set fade-out time elapses, at (608) the electronic device may display a message about whether to store the displayed moving trajectory and determine whether a certain region included in the message is selected. In more detail, the electronic device may display a message inquiring whether to store a normal memo and a secret memo which are displayed on the touch screen and receive a command indicating that the electronic device stores the normal memo and the secret memo from the user.

If the electronic device receives the command indicating that the electronic device stores the memo displayed on the touch screen from the user, at (609) the electronic device can store the displayed moving trajectory. In more detail, the electronic device may store the memos input from the input unit in the normal mode and the secret mode. For example, assuming that the electronic device receives a normal memo of a “normal” and a secret memo of a “secret” displayed according to transparency setting of 30% from the input unit. The electronic device may store the normal memo of the “normal” input in the normal mode and the secret memo of the “secret” displayed according to the transparency setting of 30%. Particularly, the secret memo of the “secret” displayed according to the transparency of 30% may be stored according to transparency of 100%. Accordingly, when the electronic device displays the stored memo, the electronic device may also display a secret memo stored in the secret mode on the touch screen according to the transparency setting of 100%.

If the electronic device receives a command indicating that the electronic device does not store the memo displayed on the touch screen, then the electronic device does not store the memo displayed on the touch screen and ends the algorithm of FIG. 6 immediately.

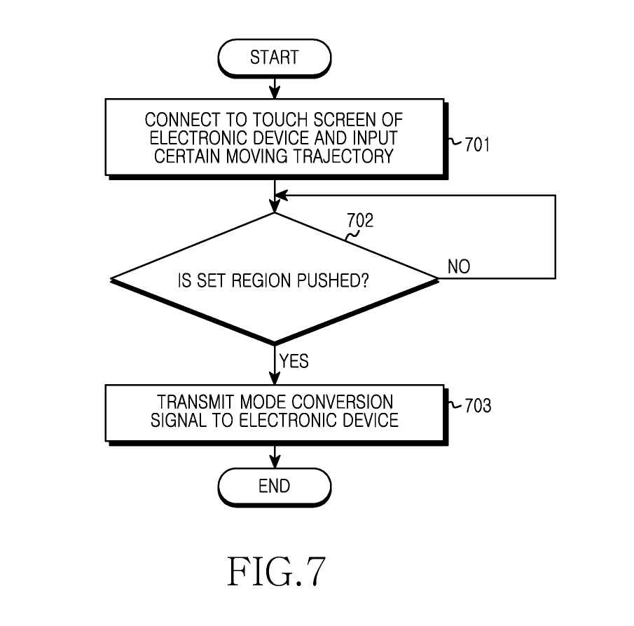

FIG. 7 is a flowchart illustrating a non-limiting example of an operational process of an input unit according to one embodiment of the present disclosure.

Referring now to FIG. 7, at (701) the input unit may connect to a touch screen of an electronic device and input a certain moving trajectory. In more detail, the input unit may connect to the touch screen and input a certain information item on the touch screen according to a moved moving trajectory.

At (702), the input unit may determine whether a set region is actuated. In more detail, the input unit may determine whether the set region is actuated by the user. Herein, the set region is a region for receiving a mode conversion signal. The input unit according to one embodiment of the present disclosure may sense that the set region is actuated by the user and allow the electronic device to perform mode conversion easily. As previously discussed, there are a number of ways to actuate the mode conversion or change the transparency setting, and the actuation can be both active or passive.

If at (702) the input unit senses that the set region is pushed, at (703) the input unit may transmit the mode conversion signal to the electronic device. In more detail, if the input unit senses that the set region is pushed by the user, it may transmit the mode conversion signal to the electronic device easily.

In addition, a person of ordinary skill in the art should understand and appreciate that the input unit is not limited to transmitting the mode conversion signal. Particularly in the case of a pushbutton, for example, a biasing unit, comprising, for example, a coil spring, could change the level of capacitance detected by the screen of the electronic device and could be a way to indicate to the electronic device that a mode conversion is desired.

In summary, there is an advantage in that the electronic device according to one embodiment of the present disclosure may convert two modes of the normal mode and the secret mode easily. In more detail, if the electronic device receives the mode conversion signal from the input unit while executing the memo application and operating in the normal mode, there is an advantage in that the electronic device may operate in the secret mode and reduce interaction of the user.

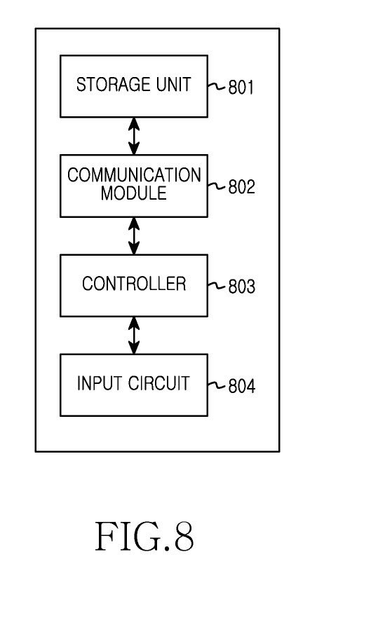

FIG. 8 is a block diagram illustrating configuration of an input unit according to one embodiment of the present disclosure.

As shown in FIG. 8, the input unit according to one embodiment of the present disclosure includes hardware such as a non-transitory storage unit 801, a communication module 802 comprising at least a transmitter, a controller 803, and an input circuit 804.

The storage unit 801 may include a program storing unit for storing a machine executable code that is executed by the controller for controlling an operation of the input unit and a data storing unit for storing data items generated while the program is executed.

The communication module 802 can include a transmitter, receiver, or transceiver that processes signals transmitted and received through an antenna to perform voice and data communication. If a set region is actuated, the communication module 802 according to one embodiment of the present disclosure transmits a mode conversion signal to an electronic device.

The controller 803, which include hardware and can comprise a processor or microprocessor, controls an overall operation of the input unit. The controller 803 according to one embodiment of the present disclosure determines whether the set region is actuated, when can include but is not limited to being pushed or slid.

The input circuit 804 provides input data generated by selection of a user to the controller 803. The input circuit 804 according to one embodiment of the present disclosure connects to a touch screen of the electronic device and inputs a certain moving trajectory.

In the above-described configuration, the controller 803 may perform an overall function of the input unit. To configure the input unit separately is to describe respective functions of the input unit separately. Accordingly, when the input unit is implemented as a real product, all of functions of the input unit may be configured to be processed in the controller 803 and some of them may be configured to be processed in the controller 803.

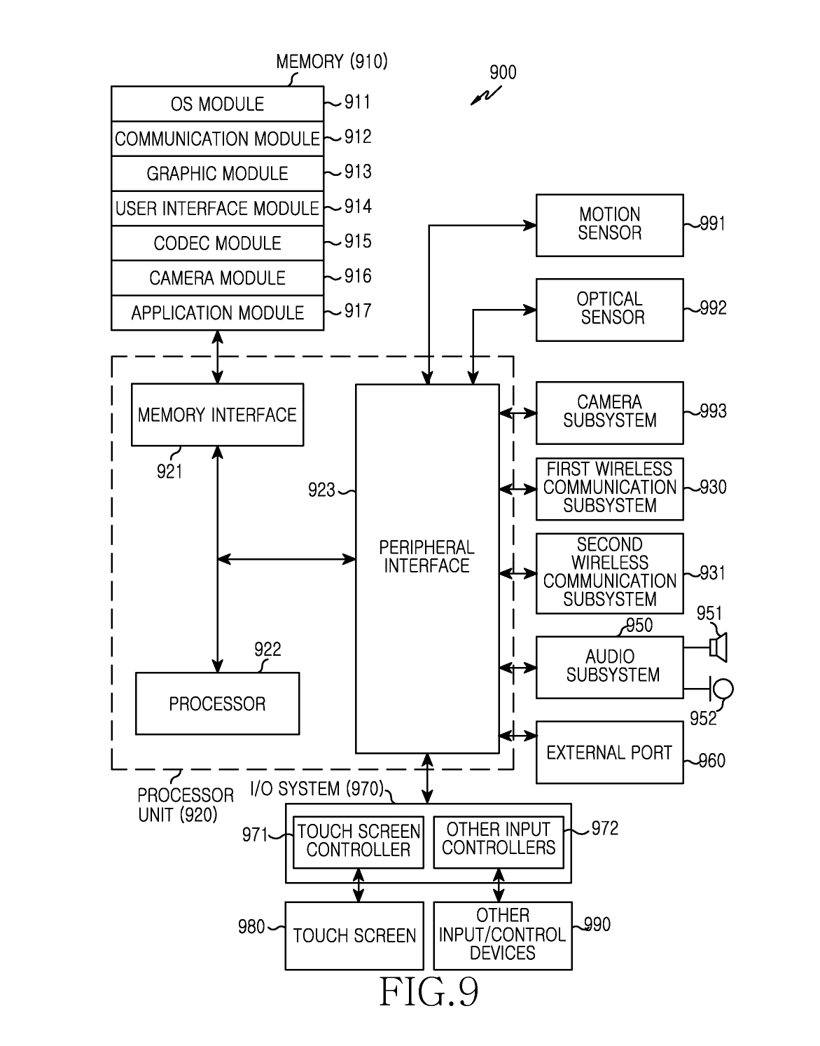

FIG. 9 is a block diagram illustrating configuration of an electronic device according to one embodiment of the present disclosure.

This electronic device denoted by 900 may comprise a portable electronic device. The electronic device 900 may be any one of apparatuses, such as a handheld portable terminal, e.g., a mobile phone, a mobile pad, a media player, a tablet computer, phablet, a handheld computer, and a Personal Digital Assistant (PDA), just to name a few non-limiting possibilities. Also, the electronic device may comprise a certain portable electronic device in which two or more functions are combined among these aforementioned non-limiting types of apparatuses.

The electronic device 900 can include a memory 910, a processor unit 920, a first wireless communication subsystem 930, a second wireless communication subsystem 931, an external port 960, an audio subsystem 950, a speaker 951, a microphone 952, an Input/Output (I/O) system 970, a touch screen 980, other input/control devices 990, a motion sensor 991, an optical sensor 992, and a camera subsystem 993. The memory 910 and the external port 960 may be a plurality of memories and external ports, respectively.

The processor unit 920, which can include an integrated circuit, comprises hardware and may include a memory interface 921, one or more processors 922, and a peripheral interface 923. In some cases, the whole processor unit 920 is simply referred to as a processor. In accordance with one embodiment of the present disclosure, if the processor unit 920 receives a mode conversion signal from an input unit, it converts a mode setup state from a first mode to a second mode. The processor unit 920 verifies that the mode setup state is set to the first mode. Also, the processor unit 920 determines whether a fade-out function is set up. If the fade-out function is setup, the processor unit 920 verifies a set fade-out time. The processor unit 920 erases a moving trajectory displayed according to set transparency after the set fade-out time elapses. Also, if the processor unit 920 receives a mode conversion signal, the processor unit is configured to convert a mode setup state from the second mode to the first mode. Also, the processor unit 920 can be configured to determine whether the mode conversion signal is received from the input unit.

The processor 922 executes machine executable code and performs several functions for the electronic device 900. Also, the processor 922 performs process and control for voice communication and data communication. Also, in addition to this normal function, the processor 922 plays a role in executing a specific software module (instruction set of machine executable code) stored in the memory 910 and performing several specific functions corresponding to the software module. In other words, the processor 922 interworks with the software modules stored in the memory 910 because the machine executable code is loaded into the processor for execution and performs the method according to one embodiment of the present disclosure.

The processor 922 may include integrated circuitry such as one or more data processors, an image processor, or a codec. The processor 922 may separately include the data processors, the image processor, or the codec. Also, the processor 922 may include several processors for performing different functions. The peripheral interface 923 connects the I/O system 970 and several peripherals to the processor 922 and the memory 910 (though the memory interface 921).

A variety of components of the electronic device 900 may be coupled by one or more communication buses (not written in reference numbers) or stream lines (not written in reference numbers).

The external port 960 is used to connect a portable electronic device (not shown) to another electronic device directly or connect the portable electronic device to another electronic device indirectly through a network (e.g., the Internet, an intranet, a wireless Local Area Network (LAN), etc.). For example, the external port 960 unit, which is not limited to, a Universal Serial Bus (USB) port or a firewire port, etc.

The motion sensor 991 and the optical sensor 992 may connect to the peripheral interface 923 and may perform several functions. For example, the motion sensor 991 and the optical sensor 992 may connect to the peripheral interface 923, sense motion of the electronic device 900, sense movement of charges, and sense light from the outside. Furthermore, a position measurement system and other sensors such as a temperature sensor, a bio-sensor, etc. may connect to the peripheral interface 923 and may perform related functions.

The camera subsystem 993 may perform a camera function like a photo and video clip recording function.

The optical sensor 992 may comprise a Charge Coupled Device (CCD) or a Complementary Metal-Oxide Semiconductor (CMOS) device.

A communication function is performed through the first and second wireless communication subsystems 930 and 931. Each of the first and second wireless communication subsystems 930 and 931 include hardware such as a radio frequency receiver and transceiver and/or a beam (e.g., infrared ray) receiver and transceiver for optical communication. The first communication subsystem 930 and the second communication subsystem 931 may be classified according to a communication network through which the electronic device 900 communicates. For example, the communication network may be, but is not limited to, a Global System for Mobile communication (GSM) network, an Enhanced Data GSM Environment (EDGE) network, a Code Division Multiple Access (CDMA) network, a W-CDMA network, a Long Term Evolution (LTE) network, an Orthogonal Frequency Division Multiple Access (OFDMA) network, a Wireless Fidelity (Wi-Fi) network, a WiMax network, or a Bluetooth network. Each of the first and second communication subsystems 930 and 931 may include a communication subsystem designed to be operated through the communication network. The first wireless communication subsystem 930 and the second wireless communication subsystem 931 may be configured as one wireless communication subsystem.

The audio subsystem 950 may connect to the speaker 951 and the microphone 952 and may be responsible for inputting and outputting an audio stream, such as a voice recognition function, a voice copy function, a digital recording function, and a phone call function. In other words, the audio subsystem 950 communicates with a user through the speaker 951 and the microphone 952. The audio subsystem 950 receives a data stream through the peripheral interface 923 of the processor unit 920 and converts the received data stream into an electric stream. The converted electric stream is transmitted to the speaker 951. The speaker 951 converts the electric stream into a sound wave to which the user may listen and outputs the converted sound wave. The microphone 952 converts a sound wave transmitted from people or other sound sources into an electric stream. The microphone 952 according to one embodiment of the present disclosure is located within a set distance with a second sensor which senses that an object is located within a set distance and collects voices. Also, if any one of at least two or more second sensors senses that an object is located within a set distance, the microphone 952 operates. The audio subsystem 950 receives the converted electric stream from the microphone 952. The audio subsystem 950 converts the received electric stream into an audio data stream and transmits the converted audio data stream to the peripheral interface 923. The audio subsystem 950 may include an attachable and detachable earphone, headphone, or headset.

The I/O system 970 may include a touch screen controller 971 and/or other input controllers 972. The touch screen controller 971 may be coupled to the touch screen 980. The touch screen 980 and the touch screen controller 971 may detect, but is not limited to, contact and motion or stop of them using not only capacitive, resistive, infrared ray, and surface acoustic wave technologies for determining one or more contact points with the touch screen 980 but also a certain multi-touch sensing technology including other proximity sensor arrangement or other elements. The other input controllers 972 may be coupled to the other input/control devices 990. The other input/control devices 990 may be pointer devices such as one or more buttons, a rocket switch, a thumb-wheel, a dial, a stick, and/or a stylus.

With continued reference to FIG. 9, the touch screen 980 provides an input/output interface between the electronic device 900 and the user. That is, the touch screen 980 transmits touch input of the user to the electronic device 900. Also, the touch screen 980 is a medium for displaying output from the electronic device 900 to the user. In other words, the touch screen 980 displays visual output to the user. This visual output has a text type, a graphic type, a video type, and a combined type of them.

The touch screen 980 may be comprised of one or more of several types of displays. For example, the touch screen 980 may be, but is not limited to, a Liquid Crystal Display (LCD), a Light Emitting Diode (LED), a Light emitting Polymer Display (LPD), an Organic Light Emitting Diode (OLED), an Active Matrix Organic Light Emitting Diode (AMOLED), or a Flexible LED (FLED). The touch screen 980 according to one embodiment of the present disclosure senses touch input from the input unit, displays a moving trajectory of the input unit, and displays the moving trajectory of the input unit according to set transparency. Also, the touch screen 980 senses touch input from the input unit and displays a moving trajectory of the input unit.

The memory 910 may coupled to the memory interface 921. The memory 910 may include a high-speed Random Access Memory (RAM) such as one or more magnetic storages, a non-volatile memory, one or more optical storages, and/or a flash memory (e.g., a NAND flash memory or a NOR flash memory), just to name a few possibilities.

The memory 910 stores software components. The software components include an Operating System (OS) module 911, a communication module 912, a graphic module 913, a user interface module 914, a CODEC module 915, a camera module 916, one or more application modules 917, etc. Also, the modules which are the software components may be expressed in a set of instructions. Accordingly, the modules comprise machine executable code are expressed in an instruction set that are executed by hardware. Also, the modules are expressed in programs that are executed by hardware.

The OS module 911 (e.g., embedded OS such as Windows, Linux, Darwin, RTXC, UNIX, OS X, or VxWorks) includes several software components for controlling a general system operation. For example, control of this general system operation unit memory management and control, storage hardware (device) control and management, power control and management, etc. This OS module 911 is executed by hardware and also functions for smooth communicating between several hardware components (devices) and software components (modules) that have been loaded into hardware. If a certain region is pushed, the memory 910 according to one embodiment of the present disclosure stores a displayed moving trajectory, and stores a moving trajectory displayed in a first mode and a moving trajectory displayed according to transparency set in a second mode.

The communication module 912 includes hardware circuitry such as a transceiver, and may communicate with other electronic devices such as a computer, a server, and/or a portable terminal through the first and second wireless communication subsystems 930 and 931 or the external port 960.

The graphic module 913 includes several software components of machine executable code that are loaded and executed by associated hardware for providing and displaying graphics on the touch screen 980. The term “graphics” unit texts, web pages, icons, digital images, videos, animations, etc. are included. The touch screen 980 according to one embodiment of the present disclosure displays a message about whether the smart rotation function is set and allows the user to select a certain region included in the message.

The user interface module 914 includes several software components comprising machine executable code that is associated with hardware for execution related to a user interface. The user interface module 914 includes contents about whether a state of a user interface is changed to any state, whether a state of a user interface is changed in any condition, etc.

The CODEC module 915 may comprises hardware circuitry such as a processor and may include software components lade into associated hardware for execution related to encoding and decoding of video files. The CODEC module 915 may include a video stream module such as an MPEG module and/or an H204 module. Also, the CODEC module 915 may include a code module for several audio files such as AAA files, AMR files, and WMA files. Also, the CODEC module 915 includes an instruction set corresponding to one embodiment of the present disclosure.

The camera module 916 includes cameral-related software components associated with camera hardware to perform camera-related processes and functions.

The application module 917 includes machine executable code that is loaded and executed by associated hardware to provide a browser function, an email function, an instant message function, a word processing function, a keyboard emulation function, an address book function, a touch list function, a widget function, a Digital Right Management (DRM) function, a voice recognition function, a voice copy function, a position determining function, a location based service function, etc.

A variety of functions of the electronic device 900, which are described above or to be described later, may be executed by one or more streaming processing, hardware including an Application Specific Integrated Circuit (ASIC), software, and/or combination of them.

In accordance with the electronic device for performing mode conversion in performing a memo function and a method thereof, the electronic device may perform the mode conversion easily without passing through a mode conversion process according to entrance to a separate menu while the user writes a memo. The apparatuses and methods of the disclosure can be implemented in hardware, and in part as firmware or as software or computer code that is stored on a non-transitory machine readable medium such as a CD ROM, a RAM, a floppy disk, a hard disk, or a magneto-optical disk or computer code downloaded over a network originally stored on a remote recording medium or a non-transitory machine readable medium and stored on a local non-transitory recording medium, so that the methods described herein are loaded into hardware such as a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor” or “microprocessor” constitute hardware in the claimed disclosure, such as, for example, integrated circuitry. Under the broadest reasonable interpretation of applicant provided definitions, the appended claims constitute statutory subject matter in compliance with 35 U.S.C. §101.

While the present disclosure has been particularly shown and described with reference to exemplary embodiments thereof, it will be understood by those skilled in the art that various changes in form and details may be made therein without departing from the spirit and scope of the present disclosure as defined by the appended claims.

What is claimed is:

1. A method for performing mode conversion in an electronic device, the method comprising:
sensing by a controller of the electronic device an input from an input unit and displaying on a display screen a moving trajectory of the input unit;
receiving a mode conversion signal from the input unit for converting a mode setup state from a first mode to a second mode; and
displaying the moving trajectory of the input unit according to set transparency.

2. The method of claim 1, wherein the mode conversion signal is received from the input unit upon actuation of a switch or button of the input unit.

3. The method of claim 2, wherein the actuation comprises a button of key of the input unit being pushed or slid.

4. The method of claim 2, wherein the actuation comprising sensing touch or presence within a predetermined distance of a certain region of the input unit.

5. The method of claim 1, wherein the first mode is a normal mode.

6. The method of claim 1, wherein the second mode is a secret mode.

7. The method of claim 1, further comprising verifying by the controller of the electronic device that the mode setup state is set to the first mode.

8. The method of claim 1, further comprising determining whether a mode conversion signal is received through a touch of a certain region of the input unit from the input unit.

9. The method of claim 1, wherein the moving trajectory of the input unit is displayed by the electronic device according to a transparency setting comprising:
determining whether a fade-out function is set up;
verifying a set fade-out time when the fade-out function is set up; and
erasing the moving trajectory displayed according to the transparency setting after the set fade-out time elapses.

10. The method of claim 9, wherein the fade-out function eliminates display of the moving trajectory of the input unit, in which the moving trajectory is displayed according to the transparency setting, after the set fade-out time elapses.

11. The method of claim 1, wherein the determination by the controller as to whether the mode conversion signal is received from the input unit t comprises:
converting the mode setup state from the second mode to the first mode when receiving the mode conversion signal; and
sensing by a touch screen of the electronic device a touch input from the input unit and displaying a moving trajectory of the input unit.

12. The method of claim 1, further comprising:
displaying a message about whether to store the displayed moving trajectory;
determining whether a certain region included in the message is selected; and
storing the displayed moving trajectory when the certain region is selected.

13. The method of claim 12, wherein the storage of the displayed moving trajectory comprises storing a moving trajectory displayed in the first mode and a moving trajectory displayed according to the set transparency in the second mode.

14. An method of operating an input unit, the method comprising:
determining whether a set region of the input unit is actuated; and
transmitting a mode conversion signal to an electronic device when the set region is actuated.

15. The method of claim 14, further comprising touching a touch screen of the electronic device and inputting a certain moving trajectory.

16. An electronic device comprising:
a processor unit for converting a mode setup state from a first mode to a second mode when receiving a mode conversion signal from an input unit through selection of a certain region of the input unit; and
a touch screen for sensing touch by the input unit, displaying a moving trajectory of the input unit, and displaying the moving trajectory of the input unit according to user-changeable transparency setting.

17. The electronic device of claim 16, wherein the first mode is a normal mode.

18. The electronic device of claim 16, wherein the second mode is a secret mode.

19. The electronic device of claim 16, wherein the processor unit verifies that the mode setup state is set to the first mode.

20. The electronic device of claim 16, wherein the processor unit determines whether a mode conversion signal is received through selection of the certain region of the input unit by actuation of a switch or button.

21. The electronic device of claim 16, wherein the processor unit determines whether a fade-out function is set up, verifies a set fade-out time when the fade-out function is set up, and eliminates display of the moving trajectory displayed on a display screen according to the set transparency after the set fade-out time elapses.

22. The electronic device of claim 21, wherein the fade-out function eliminating display of the moving trajectory of the input unit on a display screen of the electronic device, in which the moving is displayed according to the transparency setting, after the set fade-out time elapses.

23. The electronic device of claim 16, wherein the processor unit converts the mode setup state from the second mode to the first mode when receiving the mode conversion signal through selection of the certain region of the input unit and wherein the touch screen senses touch input from the input unit and displays a moving trajectory of the input unit.

24. The electronic device of claim 16, wherein the processor unit displays a message prompting whether to store the displayed moving trajectory and determines whether a particular region included in the message is selected, and further comprising a memory for storing the displayed moving trajectory when the certain region is selected.

25. The electronic device of claim 24, wherein the memory stores a moving trajectory displayed in the first mode and a moving trajectory displayed according to the transparency setting in the second mode.

26. An input unit comprising:
a controller for determining whether a set region is selected; and
a communication module for transmitting a mode conversion signal to an electronic device when the set region is actuated.

27. The input unit of claim 26, further comprising an input circuit for connecting to a touch screen of the electronic device and inputting a certain moving trajectory.
